(19) United States
(12) Patent Application Publication
(10) Pub. No.: US 2016/0298464 A1
(43) Pub. Date: Oct. 13, 2016

(54) COOLING HOLE PATTERNED AIRFOIL

(71) Applicant: United Technologies Corporation, Hartford, CT (US)

(72) Inventors: Brandon W. Spangler, Vernon, CT (US); Gina Cavallo, Watertown, CT (US)

(21) Appl. No.: 14/685,410

(22) Filed: Apr. 13, 2015

(51) Int. Cl. F01D 5/18; F01D 9/04; F01D 25/12; F01D 5/14

(52) U.S. Cl. CPC F01D 5/187; F01D 5/147; F01D 9/041; F01D 25/12; F05D 2220/32; F05D 2260/202; F05D 2230/10

(57) ABSTRACT

An airfoil having a cooling hole pattern is disclosed. The cooling hole pattern may be an offset herringbone pattern. For instance, the airfoil may have rows of cooling holes arranged in filmrows, each filmrow divided into groups of cooling holes. A first group may be oriented to direct cooling air generally radially outward over a surface of the airfoil and a second group may be oriented to direct cooling air generally radially inward over a surface of the airfoil. Between the first group and the second group of cooling holes in each filmrow, a transition region exists. The adjacent filmrows are staggered to enhance the effectiveness of the convective cooling proximate to the transition regions by causing each filmrow to direct cooling air over the transition region of an adjacent filmrow.

### STATEMENT REGARDING GOVERNMENT RIGHTS

This disclosure was made with government support under FA-8650-09-D-2923-0021 awarded by the United States Air Force. The government has certain rights in the disclosure.

### FIELD

The present disclosure relates generally to airfoils for gas turbine engine, and more specifically, to an airfoil having an offset herringbone cooling hole pattern.

### BACKGROUND

In a gas turbine engine, rotor and/or stator airfoils have cooling holes in their surfaces to allow cooling air to pass from cavities inside the airfoil and out through the cooling holes, cooling the airfoil. Groups of cooling holes may point in different directions. However, because the cooling holes point in different directions, areas of the airfoil may not receive cooling air. Such areas may be insufficiently cooled and subject to early wear and/or failure.

### SUMMARY

An airfoil comprising a cooling hole pattern is disclosed. The cooling hole pattern may include a first filmrow and a second filmrow.

A first filmrow may include a first radially outward facing portion having cooling holes oriented radially outward of an engine central longitudinal axis and over a surface of the airfoil. The first filmrow may also include first radially inward facing portion having cooling holes oriented radially inward toward the engine central longitudinal axis and over the surface of the airfoil. The first filmrow may also include a first transition boundary including a point equidistant between the first radially outward facing portion and the first radially inward facing portion, and a first transition boundary radial position including a radial distance of the first transition boundary from the engine central longitudinal axis.

A second filmrow may include a second radially outward facing portion having cooling holes oriented radially outward of the engine central longitudinal axis and over the surface of the airfoil. The second filmrow may include a second radially inward facing portion having cooling holes oriented radially inward toward the engine central longitudinal axis and over the surface of the airfoil. The second filmrow may include a second transition boundary including a point equidistant between the second radially outward facing portion and the second radially inward facing portion, and a second transition boundary radial position having a radial distance of the second transition boundary from the engine central longitudinal axis.

In various embodiments, the second transition boundary radial position does not equal (differs by more than one-half pitch from) the first transition boundary radial position.

The cooling hole pattern may include a third filmrow. The third filmrow may include a third radially outward facing portion having cooling holes oriented radially outward of the engine central longitudinal axis and over the surface of the airfoil. The third filmrow may include a third radially inward facing portion having cooling holes oriented radially inward toward the engine central longitudinal axis and over the surface of the airfoil. The third filmrow may further include a third transition boundary having a point equidistant between the third radially outward facing portion and the third radially inward facing portion, and a third transition boundary radial position including a radial distance of the third transition boundary from the engine central longitudinal axis.

In various embodiments, the third transition boundary radial position does not equal (differs by more than one-half pitch from) the first transition boundary radial position and the third transition boundary radial position does not equal (differs by more than one-half pitch from) the second transition boundary radial position.

The cooling hole pattern may include a fourth filmrow. The fourth filmrow may include a fourth radially outward facing portion including cooling holes oriented radially outward of the engine central longitudinal axis and over the surface of the airfoil, and a fourth radially inward facing portion including cooling holes oriented radially inward toward the engine central longitudinal axis and over the surface of the airfoil. The fourth filmrow may include a fourth transition boundary having a point equidistant between the fourth radially outward facing portion and the fourth radially inward facing portion and a fourth transition boundary radial position including a radial distance of the fourth transition boundary from the engine central longitudinal axis.

In various embodiments, the third transition boundary radial position equals the (differs by no more than one-half pitch from) first transition boundary radial position whereby the first filmrow and the third filmrow form a first aligned set, and the second transition boundary radial position equals (differs by no more than one-half pitch from) the fourth transition boundary radial position whereby the second filmrow and the fourth filmrow form a second aligned set.

Furthermore the airfoil may include a stator vane or a rotor blade.

An airfoil is also disclosed having a cooling hole pattern wherein the cooling hole pattern includes a plurality of filmrows having non-contiguous adjacent transition boundary radial positions. In various embodiments, the plurality of filmrows having non-contiguous adjacent transition boundary radial positions comprise a first aligned set and a second aligned set. The airfoil may include a stator vane and/or a rotor blade.

In various embodiments, each filmrow includes a radially outward facing portion including cooling holes oriented radially outward of an engine central longitudinal axis and over a surface of the airfoil and a radially inward facing portion including cooling holes oriented radially inward toward the engine central longitudinal axis and over the surface of the airfoil. Each filmrow may include a transition boundary having a point equidistant between the radially outward facing portion and the radially inward facing portion, and a transition boundary radial position including a radial distance of the transition boundary from the engine central longitudinal axis.

In various embodiments, the transition boundary radial position of each filmrow is different from at least one other filmrow whereby the plurality of filmrows have non-contiguous adjacent transition boundary radial positions. Furthermore, the transition boundary radial position of each filmrow may be different from (differs by more than one-half pitch from) one adjacent filmrow whereby the plurality of filmrows have non-contiguous adjacent transition boundary radial positions. Moreover, the transition boundary radial position of each filmrow may be different from (differs by more than one-half pitch from) two adjacent filmrows whereby the plurality of filmrows have non-contiguous adjacent transition boundary radial positions. Furthermore, the transition boundary radial position of each filmrow may be different from (differs by more than one-half pitch from) every other filmrow whereby the plurality of filmrows have non-contiguous adjacent transition boundary radial positions.

A method of forming a cooling hole pattern in an airfoil is disclosed. The method may include forming a plurality of filmrows having non-contiguous adjacent transition boundary radial positions. The airfoil may be a stator vane or a rotor blade.

The forming each of the plurality of filmrows may include forming a radially outward facing portion including cooling holes oriented radially outward of an engine central longitudinal axis and over a surface of the airfoil and forming a radially inward facing portion including cooling holes oriented radially inward toward the engine central longitudinal axis and over the surface of the airfoil. The method may also include forming a transition boundary including a point equidistant between the radially outward facing portion and the radially inward facing portion, and forming a transition boundary radial position including a radial distance of the transition boundary from the engine central longitudinal axis.

In various embodiments, the transition boundary radial position of each filmrow may be different from (differs by more than one-half pitch from) at least one other filmrow whereby the plurality of filmrows have non-contiguous adjacent transition boundary radial positions. Moreover, the transition boundary radial position of each filmrow may different from (differs by more than one-half pitch from) one adjacent filmrow whereby the plurality of filmrows have non-contiguous adjacent transition boundary radial positions. Furthermore, the transition boundary radial position of each filmrow may be different from (differs by more than one-half pitch from) two adjacent filmrows whereby the plurality of filmrows have non-contiguous adjacent transition boundary radial positions. Moreover, the transition boundary radial position of each filmrow may be different from (differs by more than one-half pitch from) every other filmrow whereby the plurality of filmrows have non-contiguous adjacent transition boundary radial positions.

### BRIEF DESCRIPTION OF THE DRAWINGS

The subject matter of the present disclosure is particularly pointed out and distinctly claimed in the concluding portion of the specification. A more complete understanding of the present disclosure, however, is best be obtained by referring to the detailed description and claims when considered in connection with the drawing figures, wherein like numerals denote like elements.

FIG. 1 illustrates a cross-sectional view of an exemplary gas turbine engine, according to various embodiments;

FIG. 2 illustrates example airfoils including a rotor and a stator, according to various embodiments;

FIG. 3A illustrates an example airfoil having an offset herringbone cooling hole pattern, according to various embodiments;

FIG. 3B illustrates an example airfoil having an offset herringbone cooling hole pattern on a leading edge of the example airfoil, according to various embodiments;

FIG. 4A illustrates an example airfoil having an offset herringbone cooling hole pattern with emphasis on various transition boundaries, according to various embodiments; and

FIG. 4B illustrates an example airfoil having an offset herringbone cooling hole pattern on a leading edge of the example airfoil and with emphasis on various transition boundaries, according to various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice embodiments of the disclosure, it should be understood that other embodiments may be realized and that logical changes and adaptations in design and construction may be made in accordance with this invention and the teachings herein. Thus, the detailed description herein is presented for purposes of illustration only and not limitation. The scope of the disclosure is defined by the appended claims. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

Furthermore, any reference to singular includes plural embodiments, and any reference to more than one component or step may include a singular embodiment or step. Surface shading lines may be used throughout the figures to denote different parts but not necessarily to denote the same or different materials.

As used herein, “pressure side” of an airfoil means the side of the airfoil having a shorter length and/or proximate to slower moving fluid and/or fluid at higher pressure as compared to the “suction side” of the airfoil. “Suction side” of an airfoil means the side of the airfoil having a longer length and/or proximate to faster moving fluid and/or fluid at a lower pressure as compared to the “pressure side” of the airfoil. Pointing or oriented “radially outward” means having a vector component extending at least partially radially outward, such as oriented to direct cooling air at least partially radially outward. Pointing “radially inward” means having a vector component extending at least partially radially inward, such as oriented to direct cooling air at least partially radially inward. Similarly, as used herein a “first direction” and a “second direction” comprise directions having a vector component extending at least partially in opposite directions, such as wherein the statement pointing in a “first direction” means having a vector component extending at least partially opposite the “second direction.”

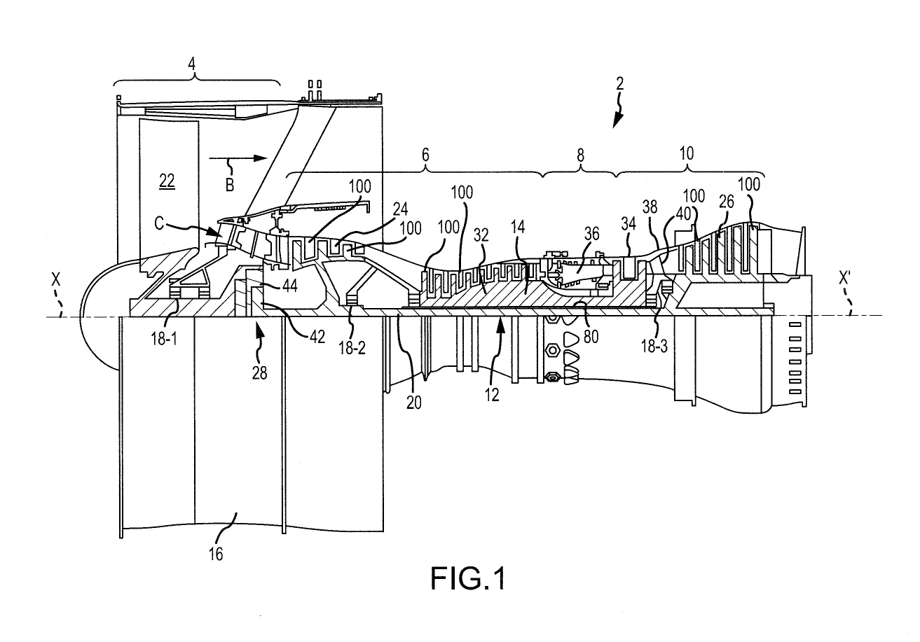

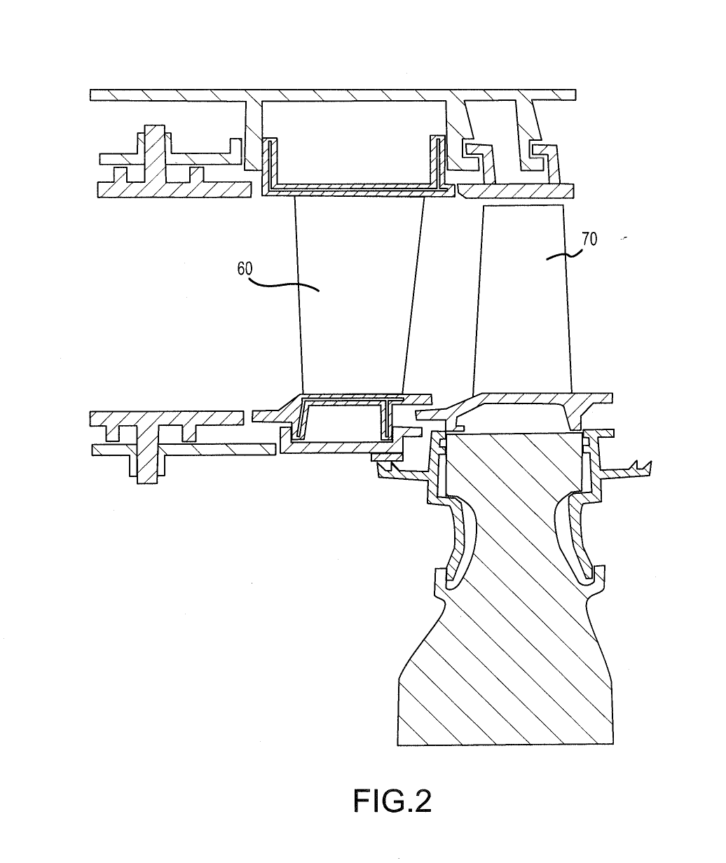

With reference to FIGS. 1 and 2, an exemplary gas turbine engine 2 is provided. Gas turbine engine 2 is a two-spool turbofan that generally incorporates a fan section 4, a compressor section 6, a combustor section 8 and a turbine section 10. Alternative engines include, for example, an augmentor section among other systems or features. In operation, fan section 4 drives air along a bypass flow-path B while compressor section 6 drives air along a core flow-path C for compression and communication into combustor section 8 then expansion through turbine section 10. Although depicted as a turbofan gas turbine engine 2 herein, it should be understood that the concepts described herein are not limited to use with turbofans as the teachings is applicable to other types of turbine engines including three-spool architectures.

Gas turbine engine 2 generally comprises a low speed spool 12 and a high speed spool 14 mounted for rotation about an engine central longitudinal axis X-X′ relative to an engine static structure 16 via several bearing systems 18-1, 18-2, and 18-3. It should be understood that bearing systems is alternatively or additionally provided at locations, including for example, bearing system 18-1, bearing system 18-2, and bearing system 18-3.

Low speed spool 12 generally comprises an inner shaft 20 that interconnects a fan 22, a low pressure compressor section 24, e.g., a first compressor section, and a low pressure turbine section 26, e.g., a second turbine section. Inner shaft 20 is connected to fan 22 through a geared architecture 28 that drives the fan 22 at a lower speed than low speed spool 12. Geared architecture 28 comprises a gear assembly 42 enclosed within a gear housing 44. Gear assembly 42 couples the inner shaft 20 to a rotating fan structure. High speed spool 14 comprises an outer shaft 80 that interconnects a high pressure compressor section 32, e.g., second compressor section, and high pressure turbine section 34, e.g., first turbine section. A combustor 36 is located between high pressure compressor section 32 and high pressure turbine section 34. A mid-turbine frame 38 of engine static structure 16 is located generally between high pressure turbine section 34 and low pressure turbine section 26. Mid-turbine frame 38 supports one or more bearing systems 18, such as 18-3, in turbine section 10. Inner shaft 20 and outer shaft 80 is concentric and rotates via bearing systems 18 about the engine central longitudinal axis X-X′, which is collinear with their longitudinal axes. As used herein, a “high pressure” compressor or turbine experiences a higher pressure than a corresponding “low pressure” compressor or turbine.

The core airflow C is compressed by low pressure compressor section 24 then high pressure compressor section 32, mixed and burned with fuel in combustor 36, then expanded over high pressure turbine section 34 and low pressure turbine section 26. Mid-turbine frame 38 includes airfoils 40, which are in the core airflow path. Turbines 26, 34 rotationally drive the respective low speed spool 12 and high speed spool 14 in response to the expansion.

Gas turbine engine 2 is, for example, a high-bypass geared aircraft engine. The bypass ratio of gas turbine engine 2 is optionally greater than about six (6). The bypass ratio of gas turbine engine 2 is optionally greater than ten (10). Geared architecture 28 is an epicyclic gear train, such as a star gear system, e.g., sun gear in meshing engagement with a plurality of star gears supported by a carrier and in meshing engagement with a ring gear, or other gear system. Geared architecture 28 has a gear reduction ratio of greater than about 2.3 and low pressure turbine section 26 has a pressure ratio that is greater than about five (5). The bypass ratio of gas turbine engine 2 is greater than about ten (10:1). The diameter of fan 22 is significantly larger than that of the low pressure compressor section 24, and the low pressure turbine section 26 has a pressure ratio that is greater than about 5:1. Low pressure turbine section 26 pressure ratio is measured prior to inlet of low pressure turbine section 26 as related to the pressure at the outlet of low pressure turbine section 26 prior to an exhaust nozzle. It should be understood, however, that the above parameters are exemplary of a suitable geared architecture engine and that the present disclosure contemplates other turbine engines including direct drive turbofans.

The next generation of turbofan engines is designed for higher efficiency, which is associated with higher pressure ratios and higher temperatures in the high speed spool 14 and other engine sections. These higher operating temperatures and pressure ratios create operating environments that cause thermal loads that are higher than thermal loads conventionally encountered. Operating conditions in high pressure compressor section 32 are often approximately 1400° F. (approximately 760° C.) or more, and operating conditions in combustor 36 are often higher. Moreover, prior cooling hole arrangements permit regions of localized temperature excursions, such as due to regions that are insufficiently convectively cooled due to the orientation of the cooling holes. Various systems to address these challenges are presented herein.

Airfoils may have cooling holes arranged in rows and each row may have at least one cooling hole pointing in a radially outward direction and at least one cooling hole pointing in a radially inward direction relative to the engine central longitudinal axis. Various regions of the airfoil, such as the leading edge, rely on the convection in the cooling hole to reduce temperature of the airfoil and/or other proximate structures; however, multiple rows of cooling holes often transition from groups of cooling holes pointing radially outwardly and groups of cooling holes pointing radially inwardly at various positions. As such, by staggering the transition of multiple rows of cooling holes from groups pointing radially outward and groups pointing radially inward the effectiveness of the convective cooling proximate to the transitions may be enhanced.

Stated differently, the present disclosure contemplates considering cooling hole orientation. For instance, for cooling holes arranged in rows (“filmrows”), each filmrow is divided into groups of cooling holes. A first group may be oriented to direct cooling air leaving the cooling hole generally radially outward relative to the engine central longitudinal axis over a surface of the airfoil, whereas a second group may be oriented to direct cooling air leaving the cooling hole generally radially inward relative to the engine central longitudinal axis and over a surface of the airfoil 100. Between the first group and the second group of cooling holes in each filmrow, a transition region exists. The transition region is the space between the first group and the second group wherein the cooling holes of that filmrow do not generally direct cooling air. For instance, the transition region is bounded at one end by cooling holes oriented to direct cooling air leaving the cooling holes generally radially outward relative to the engine central longitudinal axis over a surface of the airfoil and at the other end by cooling holes oriented to direct cooling air leaving the cooling holes generally radially inward relative to the engine central longitudinal axis over a surface of the airfoil. Intentionally staggering the transition regions of adjacent filmrows tends to enhance the effectiveness of the convective cooling proximate to the transition regions by permitting the cooling air flowing from adjacent filmrows to cool each other's transition region.

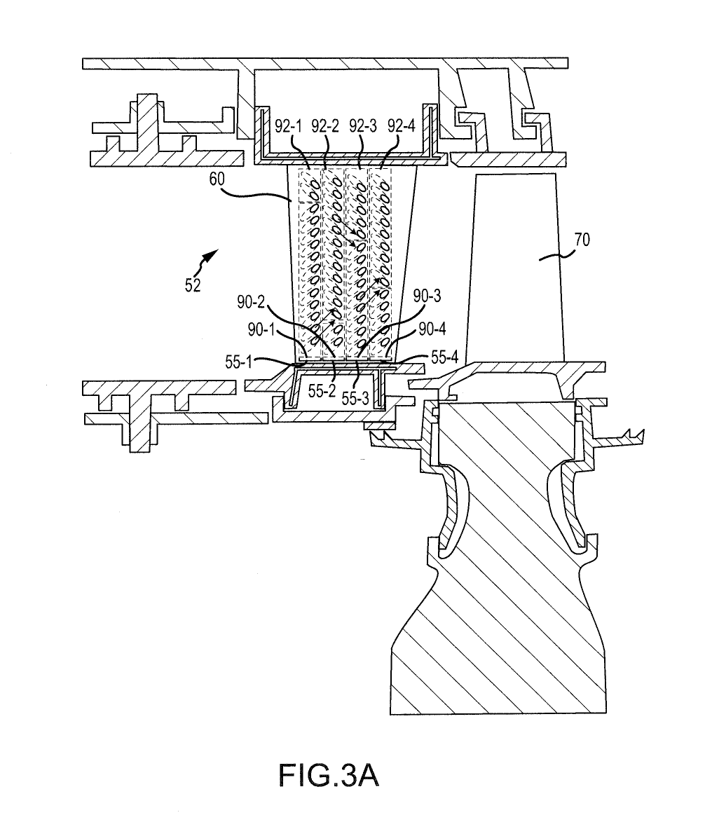

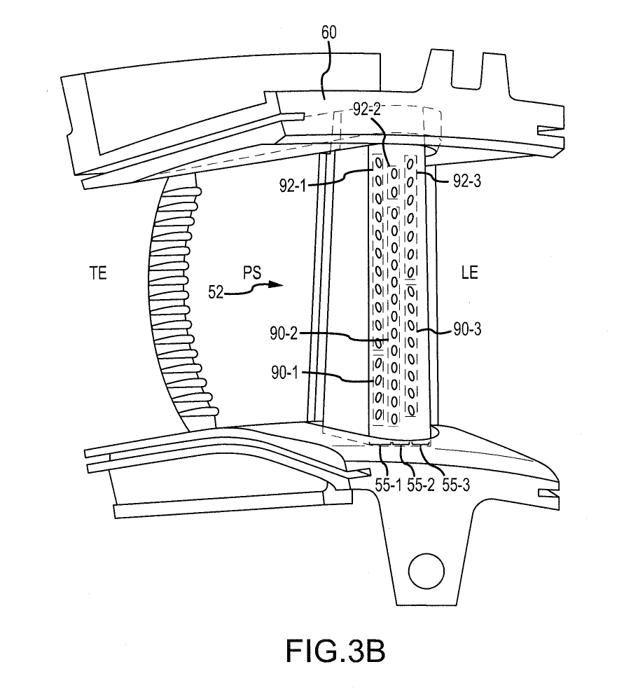

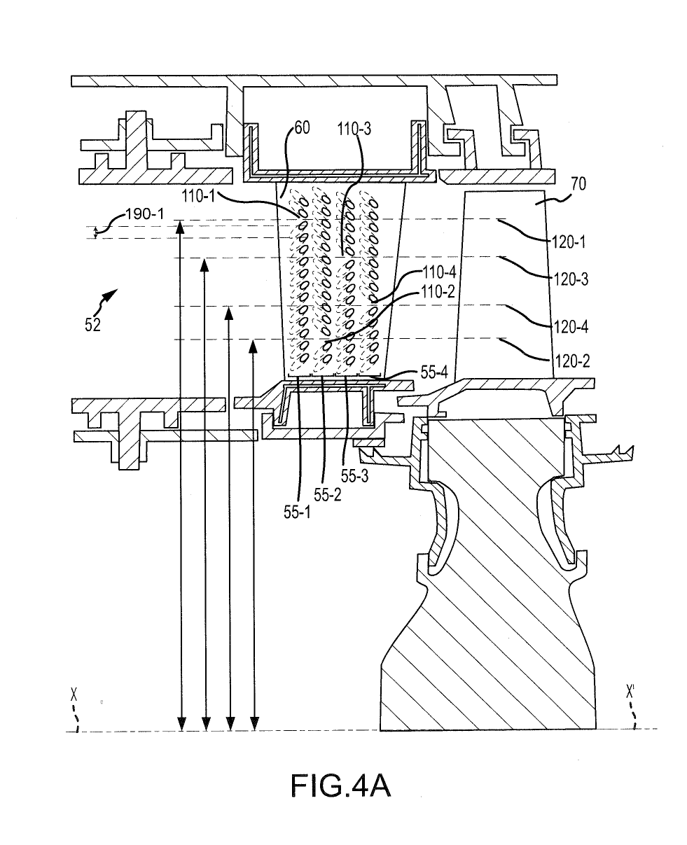

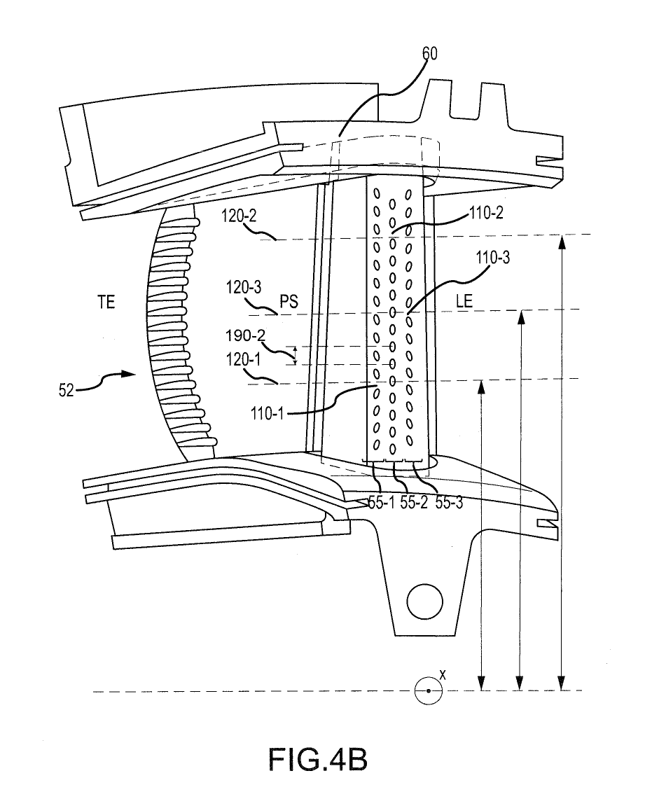

With reference to FIGS. 1 and 2, an airfoil 100 of an engine 2 may comprise a rotor blade 70 or a stator vane 60. While various aspects are described herein with reference to stator vanes 60, such as cooling hole pattern 52 (with brief reference to FIGS. 3-4), such aspects may be incorporated into rotor blades 70 in lieu of or in addition to stator vanes 60, as desired, and may be positioned on the leading edge, pressure side, and/or suction side of the airfoil 100.

For example, the transition region of each filmrow may be positioned at a different radial distance from the engine central longitudinal axis (e.g., center of a cross-sectional plane of the engine 2), so that the transition region of adjacent filmrows do not align. In various embodiments, the transition region of alternating (e.g., every other) filmrows may align (first aligned set), while the transition region of the interleaved set of alternating (e.g., every other) filmrow may align (second aligned set), yet the aligned transition regions of the first aligned set and the aligned transition regions of the second aligned set may be positioned at a different radial distance from the center of a cross-sectional plane of the engine 2. In various embodiments, the transition region of every third filmrow may align, so that there is a first aligned set, a second aligned set, and a third aligned set. Thus, one may appreciate, that numerous arrangements are contemplated wherein a given filmrow is flanked by adjacent filmrows having transition regions located at different radial distances from the engine central longitudinal axis than the given filmrow. Thus, a portion of cooling air from a filmrow may pass over and cool the transition region of one or more adjacent filmrows.

With reference now to FIGS. 2, 3A, and 3B, a cooling hole pattern 52 is disclosed. In various embodiments the cooling hole pattern 52 may comprise an arrangement of cooling holes into filmrows 55 configured to convectively cool the airfoil 100. For instance, the cooling hole pattern 52 may comprise one or more filmrows 55. The cooling hole pattern 52 may comprise a first filmrow 55-1, a second filmrow 55-2, a third filmrow 55-3, and a fourth filmrow 55-4 (FIG. 3A). While four filmrows are depicted in FIG. 3A and three filmrows are depicted in FIG. 3B for illustration purposes, one may appreciate that any number of filmrows configured to accomplish a desired cooling on a desired airfoil may be implemented.

Each filmrow 55-1, 55-2, 55-3, 55-4 may comprise a radially outward facing portion 90 and a radially inward facing portion 92. For instance, the cooling holes of each filmrow may be arranged into a row with cooling holes oriented to direct cooling air from a channel inside the airfoil through and out of the surface of the airfoil. Relative to the engine central longitudinal axis (e.g., geometric center of a cross-sectional plane of the engine 2 bisecting the stator vane 60), the radially outward facing portion 90 may comprise cooling holes oriented to direct cooling air generally radially outward from the engine central longitudinal axis. Similarly, the radially inward facing portion 92 may comprise cooling holes oriented to direct cooling air generally radially inward toward the engine central longitudinal axis. Because each filmrow 55-1, 55-2, 55-3, 55-4 may comprise a radially outward facing portion 90 and a radially inward facing portion 92, the first filmrow 55-1 may comprise a first radially outward facing portion 90-1 and a first radially inward facing portion 92-1, the second filmrow 55-2 may comprise a second radially outward facing portion 90-2 and a second radially inward facing portion 92-2, the third filmrow 55-3 may comprise a third radially outward facing portion 90-3 and a third radially inward facing portion 92-3, and the fourth filmrow 55-4 may comprise a fourth radially outward facing portion 90-4 and a fourth radially inward facing portion 92-4.

In various embodiments, each radially outward facing portion 90-1, 90-2, 90-3, 90-4, is disposed radially inward of each corresponding radially inward facing portion 92-1, 92-2, 92-3, 92-4. However, in various embodiments, each radially outward facing portion may be disposed radially outward of each corresponding radially inward facing portion. In various embodiments, the radially outward facing portion may be disposed radially outward of a corresponding radially inward facing portion of one adjacent filmrow, and radially inward of another adjacent filmrow. Thus, various arrangements are contemplated as desired to facilitate substantially uniform convective cooling of the airfoil.

Each filmrow 55-1, 55-2, 55-2, 55-4 may further comprise a transition boundary. With reference to FIGS. 4A-B, for example, first filmrow 55-1 may comprise a first transition boundary 110-1, second filmrow 55-2 may comprise a second transition boundary 110-2, third filmrow 55-3 may comprise a third transition boundary 110-3 and forth filmrow 55-4 may comprise a fourth transition boundary 110-4 (FIG. 4A). A transition boundary may comprise a point centered equidistant between the mesial ends of a radially outward facing portion of a filmrow and a radially inward facing portion of the same filmrow. For instance, first transition boundary 110-1 may be a point located equidistant between the mesial end of first radially inward facing portion 92-1 and first radially outward facing portion 90-1 of the first filmrow 55-1. Second transition boundary 110-2 may be a point located equidistant between the mesial end of second radially inward facing portion 92-2 and second radially outward facing portion 90-2 of the second filmrow 55-2. Third transition boundary 110-3 may be a point located equidistant between the mesial end of third radially inward facing portion 92-3 and third radially outward facing portion 90-3 of the third filmrow 55-3. Fourth transition boundary 110-4 may be a point located equidistant between the mesial end of fourth radially inward facing portion 92-4 and fourth radially outward facing portion 90-4 of the fourth filmrow 55-4.

With continued reference to both FIGS. 3A-B and 4A-B, but with particular focus on FIGS. 4A-B, each filmrow may comprise a transition boundary radial position. For example, first filmrow 55-1 may comprise a first transition boundary radial position 120-1, second filmrow 55-2 may comprise a second transition boundary radial position 120-2, third filmrow 55-3 may comprise a third transition boundary radial position 120-3 and fourth filmrow 55-4 may comprise a fourth transition boundary radial position 120-4. A transition boundary radial position may comprise the radial distance of the corresponding transition boundary from the engine central longitudinal axis. Different filmrows may have different transition boundary radial positions. For instance, the transition boundary radial position of each filmrow may be positioned a different radial distance from the engine central longitudinal axis, so that the transition regions of adjacent filmrows do not align. In various embodiments, the transition boundary radial position of alternating (e.g., every other) filmrow may align (first aligned set), while the transition boundary radial position of interposed alternating (e.g., every other) filmrows may align (second aligned set), yet the aligned transition regions of the first aligned set and the aligned transition regions of the second aligned set may be positioned a different radial distance from the engine central longitudinal axis. As such a non-contiguous adjacent transition boundary radial position may mean that the transition boundary radial position of each filmrow is different from at least one other filmrow, or is different from one adjacent filmrow, or is different from two adjacent filmrows, or is different from every other filmrow, or the like.

Thus, as depicted in FIG. 4A-B, a first filmrow 55-1 may comprise a first transition boundary radial position 120-1 that is located a different distance from the engine central longitudinal axis than the second transition boundary radial position 120-2 of the second filmrow 55-2. Moreover, FIGS. 4A-B depicts a third filmrow 55-3 with a third transition boundary radial position 120-3 that is located a different distance from the engine central longitudinal axis than both the first transition boundary radial position 120-1 and the second transition boundary radial position 120-3. Finally, FIG. 4A depicts a fourth filmrow 55-4 may have a fourth transition boundary radial position 120-4 that is located a different distance from the engine central longitudinal axis than the first transition boundary radial position 120-1, the second transition boundary radial position 120-2 and the third transition boundary radial position 120-3.

While each transition boundary radial position is depicted as a unique distance from the engine central longitudinal axis, in various embodiments, various transition boundary radial positions are located various distances from the engine central longitudinal axis so that non-adjacent transition boundary radial positions align. For instance, in various embodiments, each transition boundary radial position is disposed at a different distance from the engine central longitudinal axis than at least one adjacent transition boundary radial position. For instance, referring again to FIGS. 4A-B, the first transition boundary radial position 120-1 of a first filmrow 55-1 is disposed a different distance from the engine central longitudinal axis than the second transition boundary radial position 120-2 of the second filmrow 55-1. The third transition boundary radial position 120-3 of the third filmrow 55-1 may alternatively be disposed the same distance from the engine central longitudinal axis as the first transition boundary radial position 120-1 or may be disposed a different distance from the engine central longitudinal axis as both the first transition boundary radial position 120-1 and the second transition boundary radial position 120-2. As such, various embodiments are contemplated comprising filmrows 55-1, 55-2, 55-3, and 55-4 comprising non-contiguous adjacent transition boundary positions. In this manner, cooling air flowing from adjacent filmrows may variously cool adjacent transition boundaries through either convection from adjacent filmrows or film from upstream rows.

As used herein, “does not equal” as may be used in statements such as “wherein the second transition boundary radial position does not equal the first transition boundary radial position,” means that the second transition boundary radial position and the first transition boundary radial position differ by greater than one-half the radial distance between individual cooling holes of a radially outward facing portion and/or radially inward facing portion of a filmrow. Such transition boundary radial positions may be said to differ by greater than “one-half pitch.” Similarly, “the same distance” may mean equal to or less than “one-half pitch” while “a different distance” may mean to differ by greater than “one-half pitch.” FIGS. 4A-B depict distances 190-1, 190-2 which each comprise one-whole pitch, or stated differently, which each comprise a radial distance between individual cooling holes of a radially outward facing portion and/or radially inward facing portion of a film row. One-whole pitch, divided by two, equals “one-half pitch.”

With reference to FIGS. 1-4B, having discussed aspects of an airfoil 100 such as a stator vane 60 and a rotor blade 70, an airfoil 100 may be made of various materials. For instance, an airfoil 100 may be made of a single material, or different materials, or combinations of materials. For example, components of the system are made from metal. For example, aspects of an airfoil 100 are metal, such as nickel, cobalt, molybdenum, titanium, aluminum, steel, or stainless steel, though it alternatively comprises numerous other materials configured to provide support. Components of the system are optionally made from other materials such as, for example, composite, ceramic, plastics, polymers, alloys, glass, binder, epoxy, polyester, acrylic, or any material or combination of materials having desired material properties, such as heat tolerance, strength, stiffness, or weight. Portions of an airfoil 100 as disclosed herein are optionally made of different materials or combinations of materials, and/or comprise coatings. Moreover, components of the airfoil 100 are in some instances mixtures of different materials according to different ratios, gradients, and the like.

An airfoil 100 thus has multiple materials, or any material configuration suitable to enhance or reinforce the resiliency and/or support of the system when subjected to wear in an aircraft operating environment or to satisfy other desired electromagnetic, chemical, physical, or material properties, for example coefficient of thermal expansion, ductility, weight, flexibility, strength, or heat tolerance.

One such material is an austenitic nickel-chromium-based alloy such as Inconel®, which is available from Special Metals Corporation of New Hartford, N.Y., USA. Other such material includes ceramic matrix composite (CMC). Further material includes refractory metal, for example, an alloy of titanium, such as, titanium-zirconium-molybdenum (TZM).

Various benefits and advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. An airfoil comprising a cooling hole pattern, wherein the cooling hole pattern comprises:
a first filmrow comprising:
a first radially outward facing portion comprising cooling holes oriented radially outward of an engine central longitudinal axis and over a surface of the airfoil;
a first radially inward facing portion comprising cooling holes oriented radially inward toward the engine central longitudinal axis and over the surface of the airfoil;
a first transition boundary comprising a first point equidistant between the first radially outward facing portion and the first radially inward facing portion; and
a first transition boundary radial position comprising a first radial distance of the first transition boundary from the engine central longitudinal axis; and
a second filmrow comprising:
a second radially outward facing portion comprising cooling holes oriented radially outward of the engine central longitudinal axis and over the surface of the airfoil;
a second radially inward facing portion comprising cooling holes oriented radially inward toward the engine central longitudinal axis and over the surface of the airfoil;
a second transition boundary comprising a second point equidistant between the second radially outward facing portion and the second radially inward facing portion; and
a second transition boundary radial position comprising a second radial distance of the second transition boundary from the engine central longitudinal axis;
wherein the second transition boundary radial position differs by more than one-half pitch from the first transition boundary radial position.

2. The airfoil according to claim 1, further comprising a third filmrow comprising:
a third radially outward facing portion comprising cooling holes oriented radially outward of the engine central longitudinal axis and over the surface of the airfoil;
a third radially inward facing portion comprising cooling holes oriented radially inward toward the engine central longitudinal axis and over the surface of the airfoil;
a third transition boundary comprising a third point equidistant between the third radially outward facing portion and the third radially inward facing portion; and
a third transition boundary radial position comprising a third radial distance of the third transition boundary from the engine central longitudinal axis,
wherein the third transition boundary radial position does not equal the first transition boundary radial position,
wherein the third transition boundary radial position differs by more than one-half pitch from the second transition boundary radial position.

3. The airfoil according to claim 1, further comprising:
a third filmrow comprising:
a third radially outward facing portion comprising cooling holes oriented radially outward of the engine central longitudinal axis and over the surface of the airfoil;
a third radially inward facing portion comprising cooling holes oriented radially inward toward the engine central longitudinal axis and over the surface of the airfoil;
a third transition boundary comprising a third point equidistant between the third radially outward facing portion and the third radially inward facing portion; and
a third transition boundary radial position comprising a third radial distance of the third transition boundary from the engine central longitudinal axis,
a fourth filmrow comprising:
a fourth radially outward facing portion comprising cooling holes oriented radially outward of the engine central longitudinal axis and over the surface of the airfoil;
a fourth radially inward facing portion comprising cooling holes oriented radially inward toward the engine central longitudinal axis and over the surface of the airfoil;
a fourth transition boundary comprising a fourth point equidistant between the fourth radially outward facing portion and the fourth radially inward facing portion; and
a fourth transition boundary radial position comprising a fourth radial distance of the fourth transition boundary from the engine central longitudinal axis,
wherein the third transition boundary radial position differs by no more than one-half pitch from the first transition boundary radial position whereby the first filmrow and the third filmrow comprises a first aligned set, and
wherein the second transition boundary radial position differs by no more than one-half pitch from the fourth transition boundary radial position whereby the second filmrow and the fourth filmrow comprises a second aligned set.

4. The airfoil according to claim 1, wherein the airfoil comprises a stator vane.

5. The airfoil according to claim 1, wherein the airfoil comprises a rotor blade.

6. An airfoil comprising a cooling hole pattern, the cooling hole pattern comprising a plurality of filmrows having non-contiguous adjacent transition boundary radial positions.

7. The airfoil according to claim 6, wherein the plurality of filmrows having non-contiguous adjacent transition boundary radial positions comprise a first aligned set and a second aligned set.

8. The airfoil according to claim 6, wherein the airfoil comprises a stator vane.

9. The airfoil according to claim 6, wherein the airfoil comprises a rotor blade.

10. The airfoil according to claim 6,
wherein each filmrow comprises:
a radially outward facing portion comprising cooling holes oriented radially outward of an engine central longitudinal axis and over a surface of the airfoil;
a radially inward facing portion comprising cooling holes oriented radially inward toward the engine central longitudinal axis and over the surface of the airfoil;
a transition boundary comprising a point equidistant between the radially outward facing portion and the radially inward facing portion; and
a transition boundary radial position comprising a radial distance of the transition boundary from the engine central longitudinal axis,
wherein the transition boundary radial position of each filmrow differs by more than one-half pitch from at least one other filmrow whereby the plurality of filmrows have non-contiguous adjacent transition boundary radial positions.

11. The airfoil according to claim 6,
wherein each filmrow comprises:
a radially outward facing portion comprising cooling holes oriented radially outward of an engine central longitudinal axis and over a surface of the airfoil;
a radially inward facing portion comprising cooling holes oriented radially inward toward the engine central longitudinal axis and over the surface of the airfoil;
a transition boundary comprising a point equidistant between the radially outward facing portion and the radially inward facing portion; and
a transition boundary radial position comprising a radial distance of the transition boundary from the engine central longitudinal axis,
wherein the transition boundary radial position of each filmrow differs by more than one-half pitch from from one adjacent filmrow whereby the plurality of filmrows have non-contiguous adjacent transition boundary radial positions.

12. The airfoil according to claim 6,
wherein each filmrow comprises:
a radially outward facing portion comprising cooling holes oriented radially outward of an engine central longitudinal axis and over a surface of the airfoil;
a radially inward facing portion comprising cooling holes oriented radially inward toward the engine central longitudinal axis and over the surface of the airfoil;
a transition boundary comprising a point equidistant between the radially outward facing portion and the radially inward facing portion; and
a transition boundary radial position comprising a radial distance of the transition boundary from the engine central longitudinal axis,
wherein the transition boundary radial position of each filmrow differs by more than one-half pitch from from two adjacent filmrows whereby the plurality of filmrows have non-contiguous adjacent transition boundary radial positions.

13. The airfoil according to claim 6,
wherein each filmrow comprises:
a radially outward facing portion comprising cooling holes oriented radially outward of an engine central longitudinal axis and over a surface of the airfoil;
a radially inward facing portion comprising cooling holes oriented radially inward toward the engine central longitudinal axis and over the surface of the airfoil;
a transition boundary comprising a point equidistant between the radially outward facing portion and the radially inward facing portion; and
a transition boundary radial position comprising a radial distance of the transition boundary from the engine central longitudinal axis,
wherein the transition boundary radial position of each filmrow differs by more than one-half pitch from every other filmrow whereby the plurality of filmrows have non-contiguous adjacent transition boundary radial positions.

14. A method of forming an airfoil having a cooling hole pattern in an airfoil comprising:
forming a plurality of filmrows having non-contiguous adjacent transition boundary radial positions, wherein forming each of the plurality of filmrows comprises:
forming a radially outward facing portion comprising cooling holes oriented radially outward of an engine central longitudinal axis and over a surface of the airfoil; and
forming a radially inward facing portion comprising cooling holes oriented radially inward toward the engine central longitudinal axis and over the surface of the airfoil.

15. The method of forming the cooling hole pattern in an airfoil according to claim 14, wherein the airfoil comprises a stator vane.

16. The method of forming the cooling hole pattern in an airfoil according to claim 14, wherein the airfoil comprises a rotor blade.

17. The method of forming the cooling hole pattern in an airfoil according to claim 14,
wherein forming each of the plurality of filmrows further comprises:
forming a transition boundary comprising a point equidistant between the radially outward facing portion and the radially inward facing portion; and
forming a transition boundary radial position comprising a radial distance of the transition boundary from the engine central longitudinal axis,
wherein the transition boundary radial position of each filmrow differs by more than one-half pitch from at least one other filmrow whereby the plurality of filmrows have non-contiguous adjacent transition boundary radial positions.

18. The method of forming the cooling hole pattern in an airfoil according to claim 14,
wherein forming each of the plurality of filmrows further comprises:
forming a transition boundary comprising a point equidistant between the radially outward facing portion and the radially inward facing portion; and
forming a transition boundary radial position comprising a radial distance of the transition boundary from the engine central longitudinal axis,
wherein the transition boundary radial position of each filmrow differs by more than one-half pitch from from one adjacent filmrow whereby the plurality of filmrows have non-contiguous adjacent transition boundary radial positions.

19. The method of forming the cooling hole pattern in an airfoil according to claim 14,
wherein forming each of the plurality of filmrows further comprises:
forming a transition boundary comprising a point equidistant between the radially outward facing portion and the radially inward facing portion; and
forming a transition boundary radial position comprising a radial distance of the transition boundary from the engine central longitudinal axis,
wherein the transition boundary radial position of each filmrow differs by more than one-half pitch from two adjacent filmrows whereby the plurality of filmrows have non-contiguous adjacent transition boundary radial positions.

20. The method of forming the cooling hole pattern in an airfoil according to claim 14,
wherein forming each of the plurality of filmrows further comprises:
forming a transition boundary comprising a point equidistant between the radially outward facing portion and the radially inward facing portion; and
forming a transition boundary radial position comprising a radial distance of the transition boundary from the engine central longitudinal axis,
wherein the transition boundary radial position of each filmrow differs by more than one-half pitch from every other filmrow whereby the plurality of filmrows have non-contiguous adjacent transition boundary radial positions.
